(19) United States
(12) Patent Application Publication
(10) Pub. No.: US 2007/0243781 A1
(43) Pub. Date: Oct. 18, 2007

(54) Antimicrobial cloth

(76) Inventor: Ming-Tzu Chou, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/401,907

(22) Filed: Apr. 12, 2006

(51) Int. Cl. B32B 27/04; B32B 15/14; B32B 27/20; B32B 5/22; B32B 27/02; D04H 5/00; B32B 5/16; B32B 5/18; B32B 27/12; D04H 13/00; B32B 5/02; D04H 1/00; D04H 3/00

(52) U.S. Cl. 442/123; 442/13; 442/74; 442/76; 442/164; 442/334

(57) ABSTRACT

An antimicrobial cloth formed of multiple layers of antimicrobial non-woven fabric that are stitched together with a silver thread. The antimicrobial non-woven fabric is formed of antimicrobial fibers and polyester fibers, and set into shape by a hot press to have the polyester fibers be melted and bonded to the antimicrobial fibers.

### BACKGROUND OF THE INVENTION

1. Field of the Invention

The present invention relates to non-woven fabrics and more particularly, to an antimicrobial cloth formed of an antimicrobial non-woven fabric.

2. Description of the Related Art

Non-woven fabric has been intensively used for making mouth-muffles, shoe linings, air filters for air conditioner, and etc. A conventional non-woven fabric cannot inhibit growth of microbes. A non-woven fabric may be coated with an antimicrobial agent for protection against germs and bacteria. However, the antimicrobial agent may drop from the non-woven fabric easily, or may cause allergy to the user. Active carbon may be added to a non-woven fabric to remove unpleasant smell. However, active carbon becomes useless when wet. Further, a non-woven fabric with active carbon is not washable.

### SUMMARY OF THE INVENTION

The present invention has been accomplished under the circumstances in view. It is therefore the main object of the present invention to provide an antimicrobial cloth, which prohibits growth of microbes and bacteria. It is another object of the present invention to provide an antimicrobial cloth, which is washable and durable in use. According to the present invention, stitching multiple layers of antimicrobial non-woven fabric with a silver thread forms the antimicrobial cloth. Each layer of antimicrobial non-woven fabric is formed of antimicrobial fibers and polyester fibers, and set into shape by a hot press to have the polyester fibers therein be melted and bonded to the antimicrobial fibers.

### BRIEF DESCRIPTION OF THE DRAWINGS

FIG. 1 is an antimicrobial cloth manufacturing block diagram.

FIG. 2 is an exploded view of the antimicrobial cloth according to the present invention.

FIG. 3 illustrates a roll of a silver thread before application according to the present invention.

FIG. 3A-A is a cross sectional view in an enlarged scale of the silver thread according to the present invention.

FIG. 4 is a perspective view of the antimicrobial cloth according to the present invention.

FIG. 5 is a cross-sectional view in an enlarged scale of FIG. 4.

### DETAILED DESCRIPTION OF THE PREFERRED EMBODIMENT

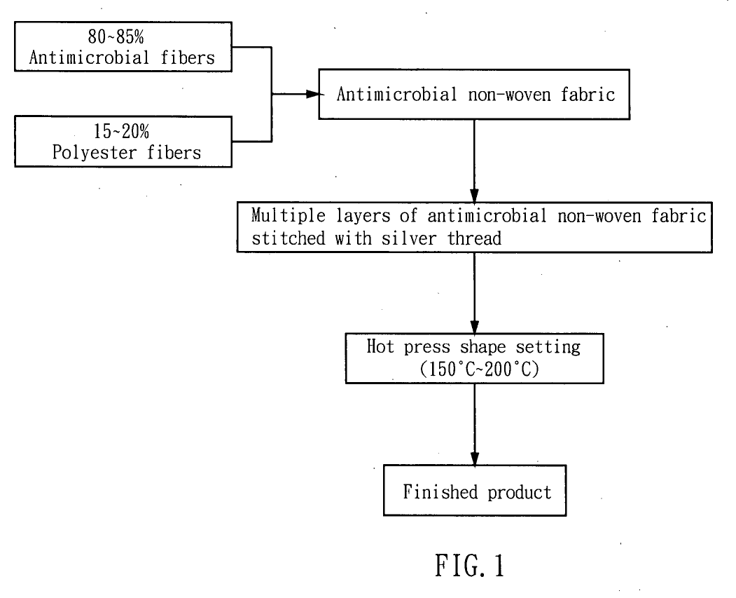

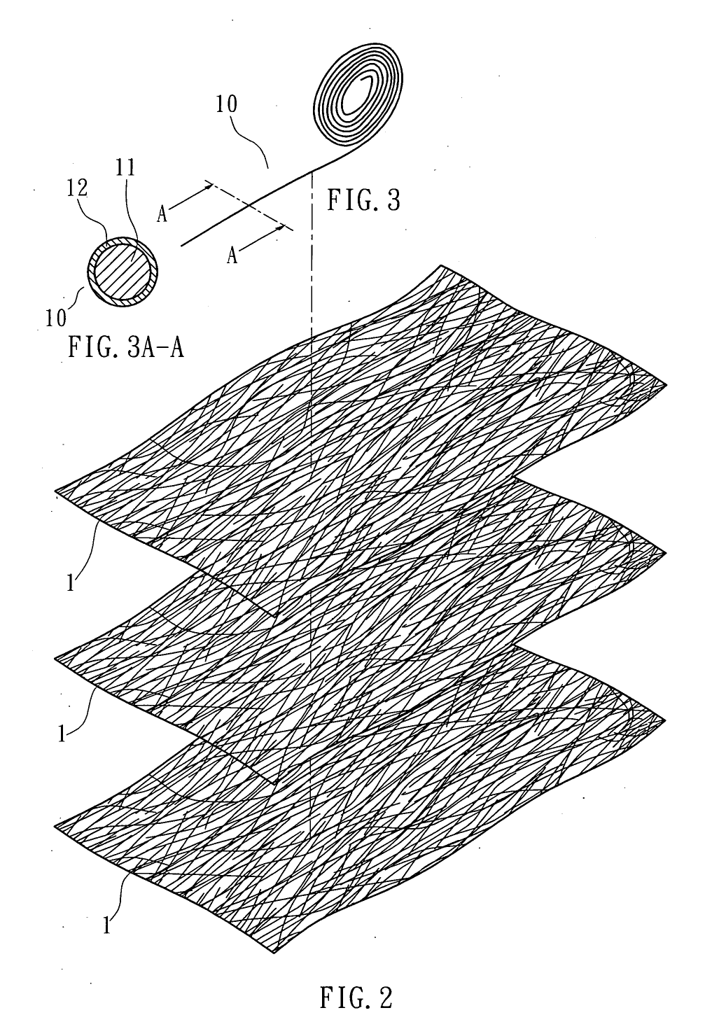

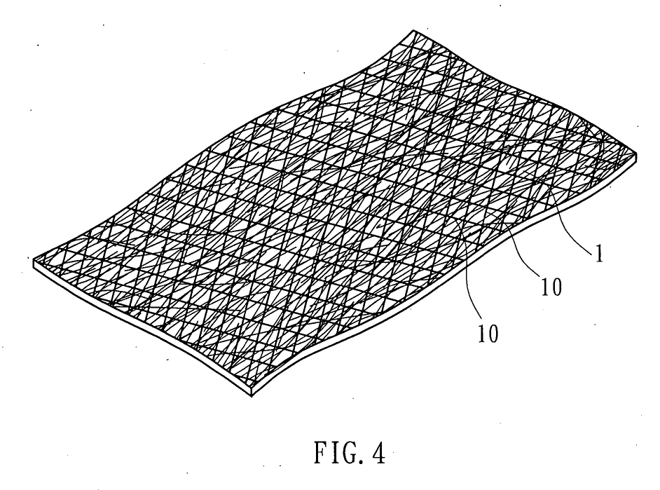

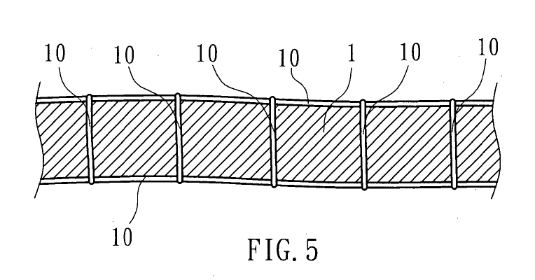

Referring to FIGS. 1-5, an antimicrobial cloth is made through a fabrication process comprising the steps of:

(a) using a blending machine to weave a non-woven fabric with 80˜85% antimicrobial fibers and 15˜20% polyester fibers, and then using a laydown system to put multiple layers of the non-woven fabric thus obtained so as to provide an antimicrobial non-woven fabric 1 subject to the desired thickness;

(b) stitching multiple layers of the antimicrobial non-woven fabric 1 thus obtained with a silver thread 10 so as to provide a multi-layer antimicrobial non-woven fabric; and

(c) using a hot press to set the multi-layer antimicrobial non-woven fabric in shape under heating temperature within 150° C.˜200° C., and the desired antimicrobial cloth is thus obtained.

The aforesaid silver thread 10 comprises a conducting core 11 and a silver covering 12 surrounding the periphery of the conducting core 11. Alternatively, the silver thread 10 can be obtained by mixing PET (polyethylene terephthalate) with silver powder. The application of heating temperature is adapted to melt polyester fibers (of which the melting point is within 100° C.˜120° C.) without melting antimicrobial fibers.

The antimicrobial cloth of the invention has the following benefits:

1. The polyester fibers are melted and bonded to the antimicrobial fibers by a hot press without using any solvent or bonding resin. This fabrication method is environment protective, and saves the manufacturing cost.

2. Because the multiple layers of the antimicrobial non-woven fabric are stitched together with a silver thread, the antimicrobial cloth does not wear when washing.

3. The silver covering of the silver thread releases silver ions free radical oxygen to destruct surrounding microbes, preventing growth of germs or bacteria.

4. The finished product of the antimicrobial cloth is practical for use to make air filter cloth, mouth-muffle, shoe lining, insole for shoe, bed covering, mop, water filter, and etc.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An antimicrobial cloth comprising multiple layers of antimicrobial non-woven fabric, and a silver thread stitched to said multiple layers of antimicrobial non-woven fabric, said multiple layers of antimicrobial non-woven fabric each being formed of antimicrobial fibers and polyester fibers, said antimicrobial fibers having a melting point higher than said polyester fibers.

2. The antimicrobial cloth as claimed in claim 1, wherein said multiple layers of antimicrobial non-woven fabric each are formed of 80˜85% antimicrobial fibers and 15˜20% polyester fibers.

3. The antimicrobial cloth as claimed in claim 1, wherein said silver thread is comprised of a conducting core and a silver covering surrounding the periphery of said conducting core.

4. The antimicrobial cloth as claimed in claim 3, wherein said silver thread is extruded from a compound of PET (polyethylene terephthalate) and silver powder.
